(19) United States
(12) Patent Application Publication
(10) Pub. No.: US 2012/0176693 A1
(43) Pub. Date: Jul. 12, 2012

(54) Layered Mirror Assembly

(75) Inventor: John S. Fitch, Los Altos, CA (US)

(73) Assignee: GOOGLE INC, Mountain View, CA (US)

(21) Appl. No.: 12/967,629

(22) Filed: Dec. 14, 2010

(51) Int. Cl. G02B 7/192; C09J 5/08; B32B 37/12

(52) U.S. Cl. 359/848; 156/306.6

(57) ABSTRACT

A mirror and method for making the mirror are described. The mirror includes at least three layers. The first layer has an outer surface and an opposed inner surface, the outer surface being a reflective surface. The second layer is positioned between the inner surface of the first layer and an inner surface of a third layer. The second layer includes a structural member adhered to the inner surface of the first layer and to the inner surface of the third layer and is configured to resist changes in geometry of the first layer. The third layer has an outer surface opposed to the inner surface, and is formed from a material having properties and dimensions such that temperature induced changes in geometry of the first layer are substantially the same as temperature induced changes in geometry of the third layer.

### TECHNICAL FIELD

This specification relates to a mirror that can be used in a heliostat system.

### BACKGROUND

Heliostats can be used to collect radiation from the Sun. Specifically, a heliostat can include one or more mirrors to direct solar rays toward a receiver mounted on a receiver tower. Some types of heliostats are capable of moving their mirror or mirrors as the Sun moves across the sky, both throughout the day and over the course of the year, in order to more efficiently direct solar rays to the receiver. Solar rays that are directed to the receiver can then be used to generate solar power. A field of heliostats can be placed surrounding one or more receivers to increase the quantity of radiation collected and optimize the amount of solar power that is generated. The solar power is converted to electricity by either the receiver or a generator that is coupled to the receiver.

A typical heliostat includes a system to control and point the mirror. Because the typical heliostat offers very low inertia (hence low resistance to fast perturbations) relative to its wind-exposed surface area, small, rapidly rising, asymmetric gusts of wind can easily move these light structures slightly off their intended targets. For similar reasons, mechanical or sound vibrations have a deleterious impact on short-term system pointing accuracy. Environmental factors, such as changes in temperature, and time can have a deleterious impact on the heliostat mirror, for example, causing warping or other damage that changes the shape or curvature of the reflective surface. Such changes can also result in the mirror reflecting solar rays off target from a receiver, or requiring additional adjustments to the position of the mirror to account for changes in the mirrors geometry.

Typical heliostat mirrors are made of glass or polymer substrates with subsequent reflective layers added. Such mirrors offer little mechanical strength and therefore most often mounted to some secondary supporting structure, e.g., an aluminum frame. This secondary structure adds material, labor and complexity that may be unacceptable in cost-sensitive applications, e.g., a large-scale concentrating solar power installation. Mirrors constructed on glass substrates alone can be easily broken when exposed to common environmental hazards, such as strong winds or large hail stones. Protecting such mirrors from these hazards generally adds additional components and cost. Polymer substrate mirrors often suffer from reduced reflectivity as compared to glass equivalents. These mirrors too can be rendered unserviceable by high winds and may become brittle or optically occluded after long exposure to high levels of ultraviolet light as are commonly present in solar energy applications. The operations commonly employed in forming either of these mirror types into large focusing optical elements add a layer of complexity, cost and opportunity for the loss of reflective quality. This can be more of a problem with two axes of curvature mirrors (e.g. paraboloids of rotation) than those curved along only one axis (troughs), but both offer challenges to their manufacturers and users.

### SUMMARY

In general, in one aspect, a mirror is described that includes three layers. The first layer has an outer surface and an opposed inner surface, the outer surface being a reflective surface. The second layer is positioned between the inner surface of the first layer and an inner surface of a third layer. The second layer includes a structural member adhered to the inner surface of the first layer and to the inner surface of the third layer and is configured to resist changes in geometry of the first layer. The third layer has an outer surface opposed to the inner surface, and is formed from a material having properties and dimensions such that temperature induced changes in geometry of the first layer are substantially the same as temperature induced changes in geometry of the third layer.

These and other embodiments can each optionally include one or more of the following features. The material for the third layer can be selected to have a coefficient of thermal expansion property such that temperature induced changes in the geometry of the first layer are substantially the same as temperature induced changes in geometry of the third layer.

The material for the third layer can be selected to have a modulus of elasticity property such that temperature induced changes in the geometry of the first layer are substantially the same as temperature induced changes in geometry of the third layer.

The second layer can further include a first adhesive positioned to adhere the first layer to the structural member of the second layer; and a second adhesive positioned to adhere the structural member of the second layer to the third layer. The structural member can include multiple structural components that form multiple voids and at least some of the first adhesive can fill at least some of the voids.

The first layer can have a curved geometry and the structural member of the second layer and third layer have substantially planar geometries. The first adhesive can fill a void between the inner surface of the first layer and the structural member that is formed from the difference in geometries of the first layer and the structural member of the second layer.

The structural member of the second layer can include polygon shaped structural components forming a honeycomb structure or a lattice structure and at least some polygon shaped voids that are formed within the structural components can be filled with the first adhesive. The structural member can include circular shaped structural components forming a circular lattice structure and at least some circular shaped voids that are formed within the structural components can be filled with the first adhesive. The structural member can include elongated structural components arranged parallel to each other and at least some rectangular shaped voids that are formed between at least some of the structural components can be filled with the first adhesive.

In some implementations, the first layer can be mirror glass of a first thickness, the structural member of the second layer can be a cardboard honeycomb structure of a second thickness and the third layer can be glass of a third thickness. The first adhesive can be a curable foam adhesive and the second adhesive can be a curable foam adhesive. The second thickness can be at least ten times larger than the first thickness and the third thickness.

The first, second and third layers have substantially planar geometries or can have substantially curved geometries, or a combination thereof (e.g., first layer curved and second and third layers planar). At least some of the second adhesive can at least partially fill at least some of the voids formed between the structural components together with the first adhesive.

In general, in another aspect, a method for making a mirror is described. A substantially planar substrate that includes at least one reflective surface is positioned onto a mandrel with the reflective surface facing toward the mandrel. The mandrel is precisely formed into a desired optical shape for the reflective surface of the substrate. The substrate is vacuum chucked onto the mandrel such that the substrate conforms to the optical shape. A structural member is adhered with a first adhesive onto a back surface of the substrate (wherein the back surface is opposite the reflective surface). The structural member includes structural components that form multiple voids. The structural member includes a front surface facing the substrate and an opposite back surface. A back layer is adhered with a second adhesive to the back surface of the structural member. The structural member and the back layer are substantially planar and the first adhesive fills a void between the front surface of the structural member and the back surface of the substrate. The void is formed from the difference in geometries of the substrate and the structural member.

These and other embodiments can each optionally include one or more of the following features. The structural member can conform to the optical shape of the substrate and the back layer can be formed into the desired optical shape of the substrate prior to adhering the back layer to the back surface of the structural member. The first adhesive can be a foam adhesive that expands to fill the voids formed by the structural components of the structural member. The back layer can be a material having a coefficient of expansion and dimensions such that temperature induced changes in geometry of the mirror glass are substantially the same as temperature induced changes in geometry of the back glass layer.

The structural member can be configured to resist changes in geometry of the mirror glass. The structural member can include multiple hexagon shaped structural components that together form a honeycomb structure and multiple hexagon shaped voids. The structural member can include multiple polygon shaped structural components that form a lattice structure and multiple polygon shaped voids. The structural member can include multiple circular shaped structural components that together form a circular lattice structure and multiple circular shaped voids. The structural member can include elongated components arranged parallel to each other and forming rectangular shaped voids between them.

In general, in another aspect, a heliostat is described that includes a base member, a mirror member and a drive system. The base member is configured to be secured to a substantially fixed surface and to support the mirror member. The mirror member includes a mirror that has a first layer having an outer surface and an opposed inner surface, the outer surface being a reflective surface. The mirror further includes a second layer positioned between the inner surface of the first layer and an inner surface of a third layer. The second layer includes a structural member that is adhered to the inner surface of the first layer and to the inner surface of the third layer and that is configured to resist changes in geometry of the first layer. The third layer has an outer surface opposed to the inner surface and is formed from a material that has properties and dimensions such that temperature induced changes in geometry of the first layer are substantially the same as temperature induced changes in geometry of the third layer. The drive system is configured to rotate the mirror about a first axis to adjust azimuth of the mirror and about a second axis to adjust elevation of the mirror.

These and other embodiments can each optionally include one or more of the following features. The material for the third layer can be selected to have a coefficient of thermal expansion property such that temperature induced changes in the geometry of the first layer are substantially the same as temperature induced changes in geometry of the third layer.

The material for the third layer can be selected to have a modulus of elasticity property such that temperature induced changes in the geometry of the first layer are substantially the same as temperature induced changes in geometry of the third layer. The second layer of the mirror can further include a first adhesive positioned to adhere the first layer to the structural member of the second layer and a second adhesive positioned to adhere the structural member of the second layer to the third layer. The structural member can include multiple structural components that form multiple voids and at least some of the first adhesive can fill at least some of the voids.

The first layer of the mirror can have a curved geometry and the structural member of the second layer and third layer can have substantially planar geometries. The first adhesive can fill a void between the inner surface of the first layer and the structural member, which void is formed from the difference in geometries of the first layer and the structural member of the second layer. In other implementations, the first, second and third layers of the mirror have substantially planar geometries. In other implementations, the first, second and third layers of the mirror have substantially curved geometries.

Particular embodiments of the subject matter described in this specification can be implemented so as to realize one or more of the following advantages. A mirror can be manufactured at a relatively low cost that is durable and can retain a desired shape while being subjected to environmental conditions and the effects of time. A reflective surface of the mirror can be formed with a precise optical shape, for example, a parabolic curve. The mirror can be formed as a relatively lightweight structure. In some implementations this is advantageous. For example, in a heliostat implementation, the less heavy the mirror, the less power required to adjust the mirror's position. The mirror can be manufactured accommodating various reflective surfaces, including for example, glass, metals and polymers. Manufacture of the mirror can be completed quickly and with only a few steps. Many different shapes of mirror can be formed by simply changing the mandrel used during manufacture.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example heliostat.

FIG. 2A shows a schematic representation of a side view of an example mirror.

FIG. 2B shows a schematic representation of a cross-sectional view of a portion of the example mirror of FIG. 2A.

FIG. 3A shows a schematic representation of a side view of an example mirror.

FIG. 3B shows a schematic representation of a cross-sectional view of a portion of the example mirror of FIG. 3A.

FIGS. 4A-D show schematic representations of cross-sectional views of example structural members.

FIG. 5 is a flowchart showing an example process for manufacturing a mirror as shown in FIGS. 2A and 2B.

FIG. 6 is a block diagram representation of an example heliostat system.

Like reference numbers and designations in the various drawings indicate like elements.

### DETAILED DESCRIPTION

A mirror is described having a sandwich like configuration, which in some implementations, is substantially symmetric. The mirror can be used in a heliostat to provide a reflective surface to reflect solar rays from the Sun toward a target, for example, a receiver. However, the mirror can be used in other applications. The mirror includes a first layer having an outer surface and an opposed inner surface, where the outer surface is the reflective surface. A second layer is positioned between the inner surface of the first layer and an inner surface of a third layer, that is, the second layer is sandwiched between the first and third layers. The second layer includes a structural member that is configured to resist changes in geometry of the first layer and that separates the inner surface of the first layer from the inner surface of the third layer. The third layer has an outer surface opposed to the inner surface and is formed from a material that has properties and dimensions that are selected such that temperature induced changes in geometry of the first layer are substantially the same as temperature induced changes in geometry of the third layer. For example, the properties can include the coefficient of thermal expansion and/or the modulus of elasticity.

The structural member of the second layer provides stiffness to resist warping of the mirror that can occur due to environmental conditions, temperature fluctuations, gravity and otherwise. Using a backing material, i.e., the third layer, that experiences similar changes in geometry due to temperature gradients as the first layer also helps to resist warping of the mirror. As is described in more detail below, because the backing material (i.e., the third layer) is not necessarily subject to the same temperature gradient as the first layer, the two layers are not necessarily formed from the same material or having the same dimensions. For example, in a heliostat implementation, the first layer is facing the Sun, whereas the third layer may be shaded some or all of the time. Therefore the temperatures and temperature gradient experienced by the first layer may be different than that experienced by the third layer.

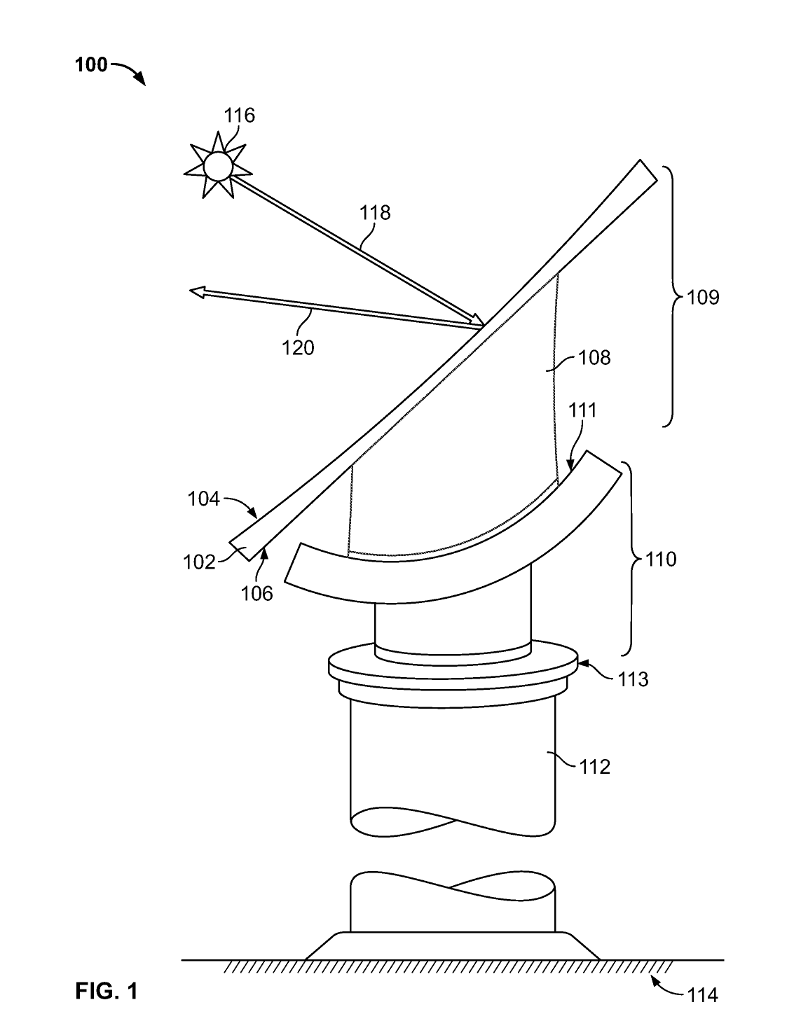

FIG. 1 shows an example heliostat 100. The heliostat 100 includes a base member 112, a transitional member 110 and a mirror member 109 that includes a mirror 102 and a support 108. The base member 112 is secured to a terrestrial surface 114. For example, the base member 112 can be a pole that extends beneath the terrestrial surface 114, or can be mounted on a pad (e.g., a concrete pad) formed on the terrestrial surface 114, or otherwise anchored so as to provide a secure support for the mirror member 109.

The heliostat 100 can include a drive system that is configured to move the mirror 102 about an azimuthal axis to adjust the azimuth position of the mirror 102. For example, the azimuthal axis can be substantially parallel to the longitudinal axis of the base member 112. In some implementations, a bearing is included at an interface 113 between the base member 112 and the transitional member 110 to provide rotational movement about the azimuthal axis of the mirror 102 relative to the base member 112. In one example, the bearing is a thrust bearing and the drive system includes a motor, although other bearings and drive systems can be used. The heliostat 100 can include a second drive system that is configured to move the mirror 102 about an elevational axis to adjust the elevation of the mirror 102. For example, the elevational axis can be substantially perpendicular to the azimuthal axis. In some implementations, a bearing can be included at an interface 111 between the transitional member 110 and the support 108 to provide rotational movement about the elevational axis of the mirror 102 relative to the transitional member 110. In one example, the bearing is a goniometric cradle bearing and the second drive system includes a motor, although other bearings and drive systems can be used.

In some implementations, a control system can be configured to control the azimuth and elevation position of the mirror 102, for example, to optimize solar radiation incident on the reflective surface 102 throughout the course of a day and to account for differing positions of the Sun on different days of the year.

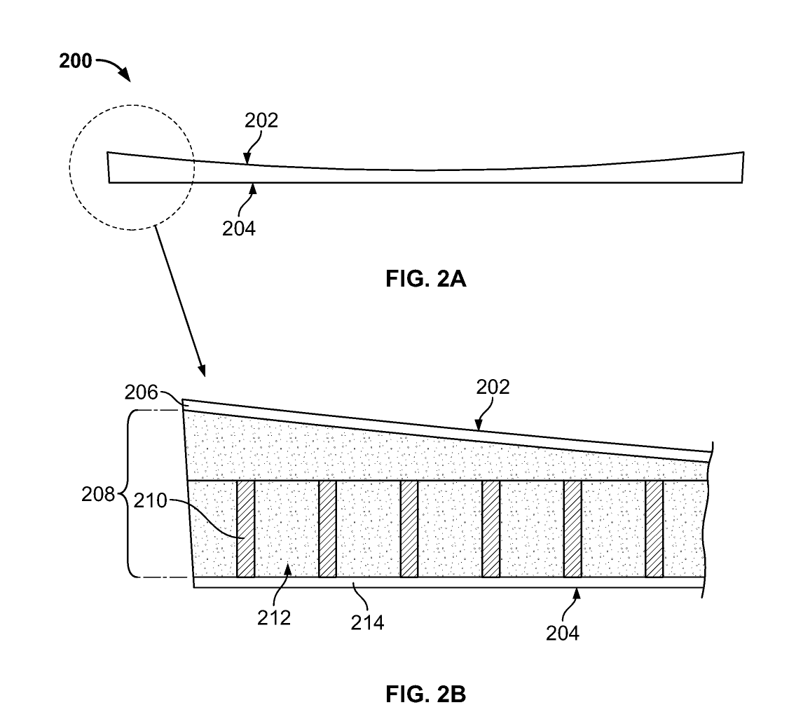

The mirror 102 includes a reflective surface 104 and a back surface 106. In the implementation shown, the reflective surface 104 is curved. In one example, the curve can be a parabolic curve. In some implementations, reflective surface 104 is substantially planar. In some implementations, the reflective surface 104 can be shaped in an asymmetrical concave revolution, such that one axis has a shorter focal length than another axis. The position of the mirror 102 in azimuth and elevation can be adjusted such that solar rays, e.g., ray 118, from the Sun 116 are incident on the reflective surface 104. The solar rays are reflected from the reflective surface (e.g., reflected ray 120), for example, toward a receiver. The heliostat 100 provides an example system where a mirror included in the mirror member 109, can be formed as described below in reference to FIGS. 2A through 4D. It should be understood that other configurations of heliostat can be used together with the mirror described herein, and the one shown in FIG. 1 is but one illustrative example.

FIG. 2A shows a schematic representation of a side view of an example mirror 200. In the implementation shown, the mirror 200 includes a reflective surface 202 that is a parabolic curve and a back surface 204 that is substantially planar. The mirror 200 can be used in a heliostat, for example, as the mirror 102 in the heliostat 100 of FIG. 1, although other uses are possible. FIG. 2B shows a schematic representation of a cross-sectional view of a portion of the example mirror 200 of FIG. 2A. The mirror 200 includes a first layer 206 that has an outer surface that forms the reflective surface 202. The first layer 206 is curved and has the shape of a parabolic curve. The mirror 200 includes a second layer 208 that is sandwiched between the first layer 206 and a third layer 214. The third layer 214 has an outer surface that provides a back surface 204 to the mirror 200.

The second layer 208 includes a structural member 210. The structural member 210 in this implementation is not curved and is substantially planar. The second layer 208 also includes a curable adhesive material 212 that adheres the structural member 210 to the inner surface of the first layer 206. The adhesive material 212 also fills a void that is created due to the first layer 206 being curved and the structural member 210 being planar. In some implementations, as shown, the structural member 210 includes a number of voids that are formed between components of the structural member 210. The adhesive material 212 can fill or substantially fill the voids and provide additional strength and stiffness to the second layer 208 when cured. By way of example, and without limitation, the adhesive material can be a two-part epoxy, a UV curable epoxy, a thermal set adhesive, a foam adhesive (e.g., two-part polyurethane foam), a thermoplastic or a silicone.

The third layer 214 is also substantially planar and is adhered to the second layer 208. A second adhesive can be used to adhere the third layer 214 to the second layer 208. The second adhesive can be the same adhesive material as the adhesive material 212 of the second layer or a different adhesive.

In some implementations the first layer 206 is formed from glass, although other non-limiting examples of materials include metal, polymers and aluminized polymers. At least the outer surface of the first layer is reflective, i.e., mirrored. The first layer 206 can be formed into a precise curved shape during manufacture, for example as described below. In a particular example, the first layer 206 is a thin layer of mirror glass (e.g., solar mirror glass available from Flabeg of Nuremberg, Germany) approximately 0.9 millimeters thick and includes a protective layer of epoxy on the inner (non-reflective) surface. The third layer 214 can also be formed from glass. However, because the third layer 214 does not need to be reflective, a less expensive glass can be used than the mirror glass used for the first layer 206. That is, using a glass for the third layer 214 that has inferior optical quality (e.g., green glass) can reduce the cost of the mirror 200. The third layer 214 can be formed from a different material altogether than the first layer 208, i.e., can be formed from something other than glass. However, the material is selected having dimensions (e.g., thickness) and properties, e.g., coefficient of thermal expansion and/or modulus of elasticity, such that changes in geometry of the third layer 214 induced by changes in temperature are substantially the same as changes in geometry of the first layer 208. If both outer layers of the composite mirror 200 undergo substantially the same changes in geometry (i.e., shrinkage and expansion), the mirror 200 is less likely to warp, deform or otherwise change shape over temperature or time. The first and third layers may be subjected to different changes in temperature, and that can be taken into consideration when selecting the material and/or dimensions for the layers.

When determining the thickness of and/or composition of the first and third layers, the temperature gradient that each layer is expected to be exposed to can be taken into account. For example, in a heliostat implementation, the first layer 208 that is facing the Sun is subjected to generally higher temperatures than the third layer 214, which is facing away from the Sun. Accordingly, each of these two layers can be subjected to different temperatures and possibly different ranges of temperatures. The expected changes in geometry for each layer are a function of the material used, thickness of the layer and expected temperatures and temperature gradients. The materials and thicknesses can be selected in view of the expected temperatures and temperature gradients so that the expected changes in geometry for the two layers will be substantially the same.

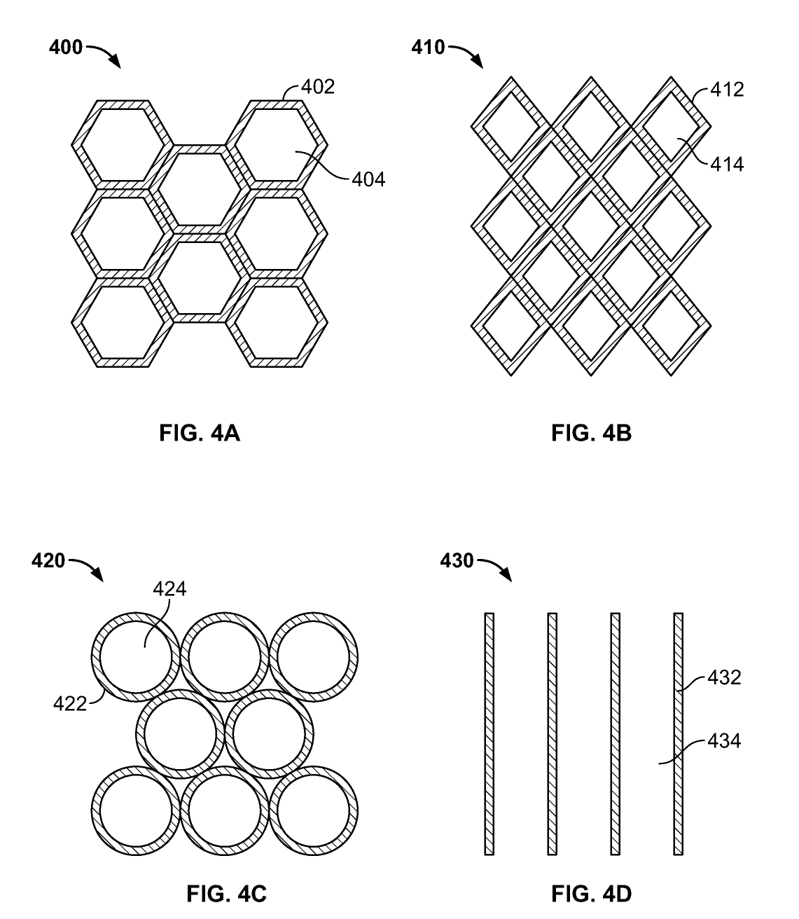

FIGS. 4A-D show schematic representations of cross-sectional views of example structural members. The structural member included in a second layer, e.g., the structural member 210 included in the second layer 208 shown in FIG. 2B, can be configured having a cross-section similar to one of the cross-sections shown in FIGS. 4A-D or otherwise; these are but a few examples. FIG. 4A is an example of a honeycomb style structural member 400. An array of polygon-shaped components 402 provide an array of polygon-shaped voids 404. In the honeycomb example, the polygons are hexagons. FIG. 4B shows an example structural member 410 where the polygons-shaped components 412 are squares or diamonds arranged in a lattice style and forming square or diamond shaped voids 414. FIG. 4C is an example structural member 420 where ring-shaped structural components 422 arranged in a ring-lattice style provide an array of circular-shaped voids 424. In other implementations, the rings can be elliptical and form elliptical-shaped voids. FIG. 4D is an example structural member 430 where elongated rectangular components 432, e.g., ribs, are arranged substantially parallel to each other and provide elongated voids 434 in between.

The voids formed by the structural components of the structural member can be filled, at least partially, with the curable adhesive material that adheres the structural member to the first layer. For example, referring again to FIG. 2B, the voids formed between the components of the structural member 210 are filled with the curable adhesive material 212. An advantage of having multiple voids filled with the curable adhesive material rather than a unitary layer of the adhesive material is less deformation of the mirror 200 due to shrinkage of the adhesive material. That is, if the second layer 208 did not include the structural member 210 and was just formed as a contiguous layer of the adhesive material 212, upon curing and over time the adhesive material 212 shrinks across the entire width of the mirror 200 and urges the first layer 206 to change shape, e.g., by pulling toward the center of the mirror 200. By contrast, if the adhesive material 212 is substantially isolated within the voids formed within the structural member 210, the shrinkage of the adhesive material is just across the width of each void, and the overall pulling effect on the first layer 206 can be considerably less. That is, the amount of deflection scales with the length of the joined materials (i.e., the adhesive joined to the first layer). If the layers share an adhesive joint that is very long (i.e., across the length and width of the mirror), the deflection can be significant. The cellular voids isolate the adhesive to short segments, thereby reducing the length of the shared joint and therefore the deflection is reduced.

The material used to form the structural member 210 is selected to provide stiffness and durability such that changes in the geometry of the first layer 206 over time or temperature excursions are minimized. In some implementations, the structural member 210 is formed from cardboard or an anisotropic foam material (e.g., anisotropic foam available from Fulcrum Composites in Michigan, USA). However, it should be understood that other materials can be used to form the structural member 210.

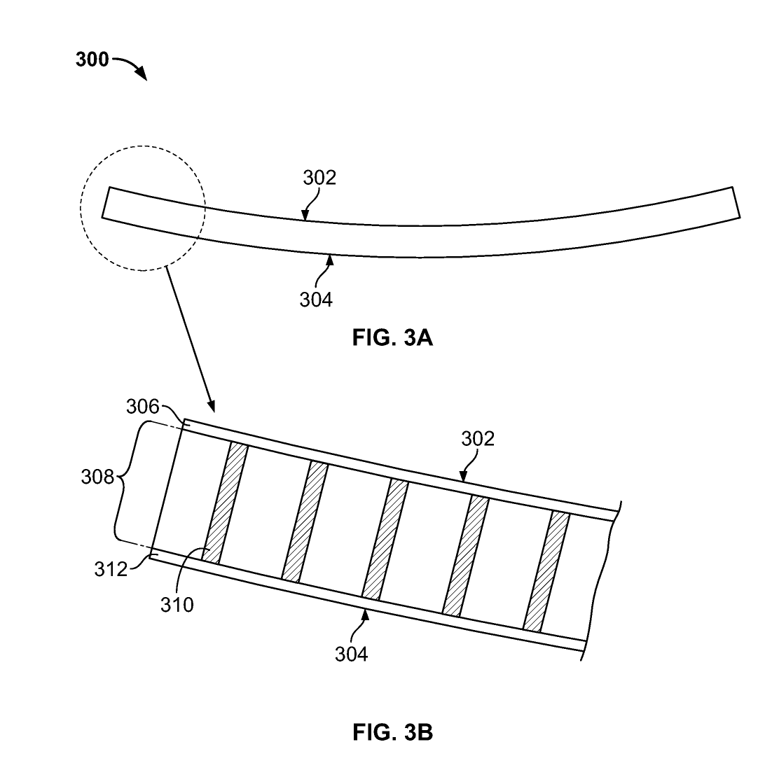

FIG. 3A shows a schematic representation of a side view of an example mirror 300. In this implementation, the mirror 300 has a curved reflective surface 302 and a curved back surface 304, that is, the entire mirror 300 has a curved geometry. FIG. 3B shows a schematic representation of a cross-sectional view of a portion of the example mirror 300 of FIG. 3A. The mirror 300 includes a first layer 306 that has an outer surface that forms the reflective surface 302. A second layer 308 includes a structural member 310 that is adhered to the inner surface of the first layer 306 and the inner surface of a third layer 312. The third layer 312 includes an outer surface that forms the back surface 304 of the mirror 300.

In the implementation shown, the second layer 308 does not include the adhesive material filling the voids 308 formed within the structural member 310. The structural member 310 is formed from a material that can either conform to the shape of the first layer 302, i.e., can be bent, or is pre-formed having the same shape as the first layer, such that the two layers can be mated together. In some implementations, the adhesive material is included in the second layer filling the voids 308 formed within the structural member 310. The structural member 310 can be configured similar to the examples shown in FIGS. 4A-D or otherwise configured.

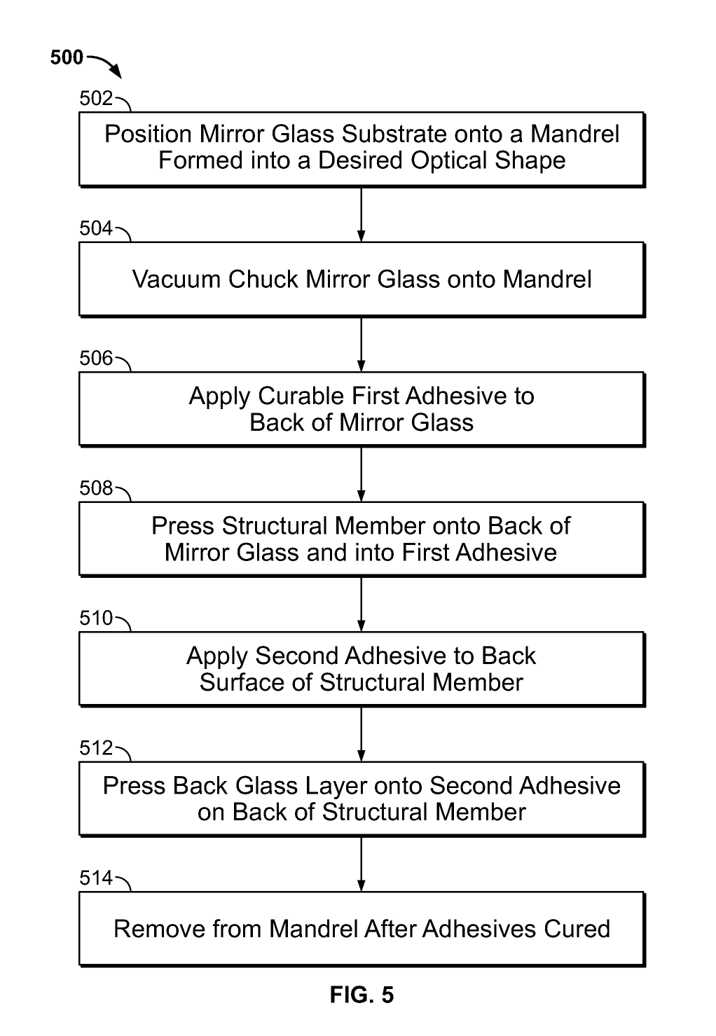

FIG. 5 is a flowchart showing an example process 500 for manufacturing a mirror as shown in FIGS. 2A and 2B. A substantially planar substrate that will be used to form the first layer 206 of the mirror 200 is positioned on a mandrel that is formed precisely into the desired optical shape of the first layer 206 (Box 502). In this particular example the substrate is mirror glass, although as discussed above, other materials can be used. In one example, the mandrel is approximately 1 meter by 1 meter and has a two-dimensional convex profile that is a segment of a paraboloid with an approximately 70 meter focal length. The mirror glass is vacuum chucked reflective-surface down onto the mandrel by a vacuum apparatus that can act through apertures in the surface of the mandrel (Box 504). The vacuum force is sufficient to conform the mirror glass to the shape of the mandrel while the vacuum is applied.

While the mirror glass is being vacuum-held on the mandrel, a curable adhesive 212 (preferably rapidly curing) is applied to the exposed back surface of the mirror glass (Box 506). In one example, the adhesive is a two-part polyurethane foam adhesive, e.g., FROTH-PAK™ 180 available from the Dow Chemical Company. Before the adhesive cures, the structural member 210 is pressed onto the back surface of the mirror glass 206 and into the adhesive material 212 (Box 508). In other implementations, the adhesive is applied to the structural member which is then pressed onto the back surface of the mirror glass. In other implementations, a two part adhesive is used with the first part applied to the back surface of the mirror glass and the second part applied to the structural member 210. The two are then joined and the two part adhesive cures.

Depending on the adhesive material used, the adhesive material can expand to fill the voids 212 formed within the structural member 210, as shown. The structural member 210 is planar as compared to the curved mirror glass 206, and the adhesive material fills the void between the back surface of the mirror glass and the front surface of the structural member 210 that is created by the difference in geometries between the two. A second adhesive is applied to the exposed back surface of the structural member 210 (Box 510). The second adhesive can be the same material as the adhesive 212 or a different material. A substantially planar layer of glass, i.e., the third layer 214, is pressed onto the second adhesive on the back of the structural member 210 (Box 512). The glass-structural-member-glass assembly is held on the vacuum mandrel until the adhesives are cured and then removed (Box 514). In the example described where the adhesive is a two-part polyurethane foam adhesive, curing can take less than one minute, although other cure times are possible. The mirror 200 once removed from the mandrel is rigid and will substantially retain the precise shape of the reflective surface 202. The mirror 200 is stiff enough to resist gravity and wind loads while holding the desired optical shape of the reflective surface. In some implementations, a +/−1 millimeter tolerance can be achieved over the face of a 1 m×1 m reflective surface, and can be expected to maintain the tolerance for an operating life of approximately 25 years.

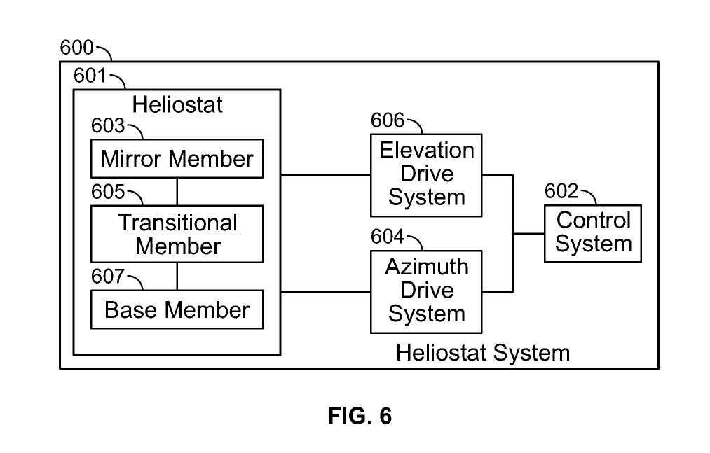

FIG. 6 is a block diagram representation of an example heliostat system 600. The heliostat system 600 includes the heliostat 601, a control system 602 and illustrates drive systems, i.e., azimuth drive system 604 and elevation drive system 606, that are configured to move one or more components of the heliostat 601. The heliostat 601 can be controlled by the control system 602 that can either be integral to the heliostat 601, separate but dedicated to the heliostat 601, remote from the heliostat 601 or a combination of the above. That is, the heliostat 601 can be controlled by a local controller that is in communication with a remote controller. The control system 602 communicates with the drive systems 604, 606 to provide instructions to control movement of the mirror included in the mirror member 603 in azimuth and elevation. The control system 602 can communicate with the heliostat 601 over a wired or wireless connection. The communication can occur using a network that can include one or more local area networks (LANs), a wide area network (WAN), such as the Internet, a wireless network, such as a cellular network, or a combination of all of the above.

In some implementations, the azimuth drive system 604 can be implemented as a first motor that is coupled to the base member 607 of the heliostat 601 and configured to turn a gear coupled to a transitional member 605. The transitional member 605 is a member positioned between the base member 607 and the mirror member 603. The first motor can be controlled by the control system 602, such that the first motor can be operated to rotate the transitional member 605 about the stationary base member 607, so as to change the direction the mirror included in the mirror member 603 is pointing. In other implementations, the azimuth drive system 604 can be implemented as a first cable drive system, for example, that includes a cable around the transitional member 605 that can be operated to rotate the transitional member 605 about the stationary base member 607. Other forms of drive mechanism can be used, and the motor and cable drive are but a couple of examples.

In some implementations, the elevation drive system 606 can be implemented as a second motor that is coupled to the transitional member 605 and configured to turn a gear coupled to the mirror member 603. The second motor can be controlled by the control system 602, such that the second motor can be operated to change the elevation of the mirror included in the mirror portion 603. In other implementations, the elevation drive system 606 can be implemented as a second cable drive system. Other forms of drive mechanism can be used, and the motor and cable drive are but a couple of examples.

The control system 602 can be configured to control the position of the mirror included in the mirror member 603 based on the position of the Sun, which can be the actual position or a predicted position or both. For example, the position of the Sun can be predicted based on the location on Earth of the heliostat 601, the time of day and the date of year. The desired azimuth and elevation of the mirror can be determined based on the predicted position of the Sun and the relative position of the target, i.e., a receiver toward which solar rays reflected off the mirror are directed.

A number of embodiments have been described. Nevertheless, it will be understood that various modifications may be made without departing from the spirit and scope of the invention.

In addition, the logic flow depicted in FIG. 5 does not require the particular order shown, or sequential order, to achieve desirable results. In addition, other steps may be provided, or steps may be eliminated, from the described flow, and other components may be added to, or removed from, the described systems. Accordingly, other embodiments are within the scope of the following claims.

What is claimed is:

1. A mirror comprising:
a first layer having an outer surface and an opposed inner surface, the outer surface comprising a reflective surface;
a second layer positioned between the inner surface of the first layer and an inner surface of a third layer, the second layer including a structural member adhered to the inner surface of the first layer and to the inner surface of the third layer and configured to resist changes in geometry of the first layer; and
the third layer having an outer surface opposed to the inner surface, the third layer comprising a material having properties and dimensions such that temperature induced changes in geometry of the first layer are substantially the same as temperature induced changes in geometry of the third layer.

2. The mirror of claim 1, wherein material for the third layer is selected to have a coefficient of thermal expansion property such that temperature induced changes in the geometry of the first layer are substantially the same as temperature induced changes in geometry of the third layer.

3. The mirror of claim 1, wherein material for the third layer is selected to have a modulus of elasticity property such that temperature induced changes in the geometry of the first layer are substantially the same as temperature induced changes in geometry of the third layer.

4. The mirror of claim 1, the second layer further comprising:
a first adhesive positioned to adhere the first layer to the structural member of the second layer; and
a second adhesive positioned to adhere the structural member of the second layer to the third layer;
wherein the structural member comprises a plurality of structural components that form a plurality of voids and at least some of the first adhesive fills at least some of the voids.

5. The mirror of claim 4, wherein:
the first layer has a curved geometry and the structural member of the second layer and third layer have substantially planar geometries; and
the first adhesive fills a void between the inner surface of the first layer and the structural member wherein the void is formed from the difference in geometries of the first layer and the structural member of the second layer.

6. The mirror of claim 4, wherein the structural member of the second layer comprises a plurality of polygon shaped structural components forming a honeycomb structure and at least some polygon shaped voids that are formed within the structural components are filled with the first adhesive.

7. The mirror of claim 4, wherein the structural member of the second layer comprises a plurality of polygon shaped structural components forming a lattice structure and at least some polygon shaped voids that are formed within the structural components are filled with the first adhesive.

8. The mirror of claim 4, wherein the structural member of the second layer comprises a plurality of circular shaped structural components forming a circular lattice structure and at least some circular shaped voids that are formed within the structural components are filled with the first adhesive.

9. The mirror of claim 4, wherein the structural member of the second layer comprises a plurality of elongated structural components arranged parallel to each other and at least some rectangular shaped voids that are formed between at least some of the structural components are filled with the first adhesive.

10. The mirror of claim 4, wherein:
the first layer comprises mirror glass of a first thickness;
the structural member of the second layer comprises a cardboard honeycomb structure of a second thickness;
the third layer comprises glass of a third thickness;
the first adhesive comprises a curable foam adhesive; and
the second adhesive comprises a curable foam adhesive;
wherein the second thickness is at least ten times larger than the first thickness and the third thickness.

11. The mirror of claim 1, wherein the first, second and third layers have substantially planar geometries.

12. The mirror of claim 1, wherein the first, second and third layers have substantially curved geometries.

13. The mirror of claim 1, wherein at least some of the second adhesive at least partially fills at least some of the voids formed between the structural components together with the first adhesive.

14. A method for making a mirror comprising:
positioning a substantially planar substrate that includes at least one reflective surface onto a mandrel with the reflective surface facing toward the mandrel, wherein the mandrel is precisely formed into a desired optical shape for the reflective surface;
vacuum chucking the substrate onto the mandrel such that the substrate conforms to the optical shape;
adhering with a first adhesive a structural member comprising a plurality of structural components that form a plurality of voids onto a back surface of the substrate, wherein the back surface is opposite the reflective surface and wherein the structural member includes a front surface facing the substrate and an opposite back surface; and
adhering with a second adhesive a back layer to the back surface of the structural member.

15. The method of claim 14, wherein the structural member and the back layer are substantially planar and the first adhesive fills a void between the front surface of the structural member and the back surface of the substrate, the void formed from the difference in geometries of the substrate and the structural member.

16. The method of claim 14, wherein the structural member conforms to the optical shape of the substrate, the method further comprising:
forming the back layer into the desired optical shape of the substrate prior to adhering the back layer to the back surface of the structural member.

17. The method of claim 14, wherein the first adhesive comprises a foam adhesive that expands to fill the voids formed by the structural components of the structural member.

18. The method of claim 14, wherein the back layer comprises a material having a coefficient of expansion and dimensions such that temperature induced changes in geometry of the mirror glass are substantially the same as temperature induced changes in geometry of the back glass layer.

19. The method of claim 14, wherein the structural member is configured to resist changes in geometry of the mirror glass.

20. The method of claim 14, wherein the structural member comprises a plurality of hexagon shaped structural components forming a honeycomb structure and a plurality of hexagon shaped voids.

21. The method of claim 14, wherein the structural member comprises a plurality of polygon shaped structural components forming a lattice structure and a plurality of polygon shaped voids.

22. The method of claim 14, wherein the structural member comprises a plurality of circular shaped structural components forming a circular lattice structure and a plurality of circular shaped voids.

23. The method of claim 14, wherein the structural member comprises a plurality of elongated components arranged parallel to each other and forming a plurality of rectangular shaped voids between them.

24. A heliostat comprising:
a base member configured to be secured to a substantially fixed surface and to support a mirror member;
the mirror member including a mirror comprising:
a first layer having an outer surface and an opposed inner surface, the outer surface comprising a reflective surface;
a second layer positioned between the inner surface of the first layer and an inner surface of a third layer, the second layer including a structural member adhered to the inner surface of the first layer and to the inner surface of the third layer and configured to resist changes in geometry of the first layer; and
the third layer having an outer surface opposed to the inner surface, the third layer comprising a material having properties and dimensions such that temperature induced changes in geometry of the first layer are substantially the same as temperature induced changes in geometry of the third layer; and
a drive system configured to rotate the mirror about a first axis to adjust azimuth of the mirror and about a second axis to adjust elevation of the mirror.

25. The heliostat of claim 24, wherein material for the third layer is selected to have a coefficient of thermal expansion property such that temperature induced changes in the geometry of the first layer are substantially the same as temperature induced changes in geometry of the third layer.

26. The heliostat of claim 24, wherein material for the third layer is selected to have a modulus of elasticity property such that temperature induced changes in the geometry of the first layer are substantially the same as temperature induced changes in geometry of the third layer.

27. The heliostat of claim 24, the second layer of the mirror further comprising:
a first adhesive positioned to adhere the first layer to the structural member of the second layer; and
a second adhesive positioned to adhere the structural member of the second layer to the third layer;
wherein the structural member comprises a plurality of structural components that form a plurality of voids and at least some of the first adhesive fills at least some of the voids.

28. The heliostat of claim 27, wherein:
the first layer of the mirror has a curved geometry and the structural member of the second layer and third layer have substantially planar geometries; and
the first adhesive fills a void between the inner surface of the first layer and the structural member that is formed from the difference in geometries of the first layer and the structural member of the second layer.

29. The heliostat of claim 24, wherein the first, second and third layers of the mirror have substantially planar geometries.

30. The heliostat of claim 24, wherein the first, second and third layers of the mirror have substantially curved geometries.

31. The heliostat of claim 24, further comprising:
a transitional member positioned between the base member and the mirror member;
a first bearing included at an interface between the base member and the transitional member; and
a second bearing included at an interface between the transitional member and a support included in the mirror member;
wherein the drive system includes an azimuthal drive system configured to rotate the transitional member about the first bearing to adjust azimuth of the mirror and an elevational drive system configured to pivot the support of the mirror member about the second bearing to adjust elevation of the mirror.

32. The heliostat of claim 31, wherein the first bearing comprises a thrust bearing and the second bearing comprises a goniometric cradle bearing.

33. The heliostat of claim 31, wherein the azimuthal drive system comprises a first motor and the elevational drive system comprises a second motor.
